(19) United States
(12) Patent Application Publication
(10) Pub. No.: US 2014/0318022 A1
(43) Pub. Date: Oct. 30, 2014

(54) MAGNETIC WEATHER SEAL

(71) Applicant: Brandon Bell, Saratoga Springs, UT (US)

(72) Inventor: Brandon Bell, Saratoga Springs, UT (US)

(21) Appl. No.: 13/870,852

(22) Filed: Apr. 25, 2013

(51) Int. Cl. E06B 7/16

(52) U.S. Cl. CPC E06B 7/16
USPC 49/478.1; 49/506; 428/354; 428/352

(57) ABSTRACT

Magnetic weather stripping and methods of making and using the magnetic weather stripping are described. Magnetic weather stripping may include a compressible insulative core, a strip magnet permanently affixed to the insulative core, and an adhesive layer applied to a second surface of the insulative core opposite the first surface of the insulative core. The weather stripping may be attached to a door or window frame using the adhesive. A separate magnet strip may be applied to the door or window if the door or window is not made of a ferromagnetic material such as steel.

### PRIORITY

This application claims priority to U.S. Provisional Patent Application No. 61/638,935, entitled Compressible And Expandable Magnetic Weather Seal filed on Apr. 26, 2012, which is incorporated herein by reference in its entirety.

### FIELD

This application relates generally to weather seals. In particular, this application relates to weather seals for openings selectively held together with magnets.

### BACKGROUND

Most buildings and vehicles which are climate controlled have foam and rubber weather seals in windows and doors. These seals often compress over time or otherwise deteriorate. This compression and/or deterioration can causes gaps between a door or window and their fixed frames. These gaps can allow air, moisture, dust, and bugs to infiltrate into the climate controlled environment, making efforts to control the temperature and climate inside inefficient and wasteful, and sometimes ineffective.

Also, as temperatures change, doors and windows may warp. This warping may cause certain areas of the weather seal to compress, and as the temperatures change, the door or window will warp in the opposite way leaving gaps between the operational door or window and their fixed frame. If any gap is larger than the installed foam or rubber seal (for example, you have a 0.25 inch foam or rubber weather seal) the window or door is not sealed, compromising the energy efficiency and comfort of the climate controlled space.

### SUMMARY

Exemplary magnetic weather stripping and methods of making and using the magnetic weather stripping are described in this specification. Magnetic weather stripping may include a compressible insulative core, a strip magnet permanently affixed to a first surface of the insulative core, and an adhesive layer applied to a second surface of the insulative core opposite the first surface of the insulative core. The magnetic weather stripping may also include a separate magnet strip.

In some embodiments, the compressible insulative core may be formed using at least three strips of vinyl fabric. The at least three strips of vinyl fabric may be connected to each other to form a general box or I-shape. The weather stripping may be configured to be attached to the frame of a door or window using the adhesive layer, and the separate magnet strip may include an adhesive layer configured to attach to magnet strip to a door or window. The weather stripping may be packaged and shipped in a roll. Additionally, the adhesive layer may be protected with a release layer prior to installation of the weather stripping.

The weather stripping may be installed by following the steps of: providing weather stripping having a compressible strip and a magnet strip; applying the compressible strip to a frame; and applying the magnet strip to the door or window corresponding to the frame. The compressible strip may include a strip magnet. The magnet strip may be configured to magnetically attach to the strip magnet when the door or window is closed. In some embodiments, the compressible strip may include a compressible insulative core, a strip magnet permanently affixed to a first surface of the insulative core, and an adhesive layer applied to a second surface of the insulative core opposite the first surface of the insulative core. The compressible insulative core may be formed of vinyl or foam. In some embodiments, when the window or door is closed, the magnet strip attaches to the compressible strip, and when the window or door is opened, the magnet strip becomes unattached from the compressible strip and the compressible strip remains attached to the frame.

### BRIEF DESCRIPTION OF THE DRAWINGS

The following description can be better understood in light of Figures, in which:

FIG. 1 illustrates an exemplary magnetic weather strip system;

FIGS. 2A-2B illustrate other views of an exemplary magnetic weather strip system;

FIG. 3 illustrates an exemplary magnetic weather strip system installed on a door;

FIG. 4A illustrates a cross-sectional view an exemplary magnetic weather strip system installed on an open door; and

FIG. 4B illustrates a cross-sectional view an exemplary magnetic weather strip system installed on a closed door.

Together with the following description, the Figures demonstrate and explain the principles of magnetic weather strip systems and methods for making and using the systems. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses embodiments of magnetic weather stripping used with a door of a building, other embodiments may be used with windows and doors and other openings in spaces which are climate or temperature controlled, such as buildings, trailers, vehicles, etc.

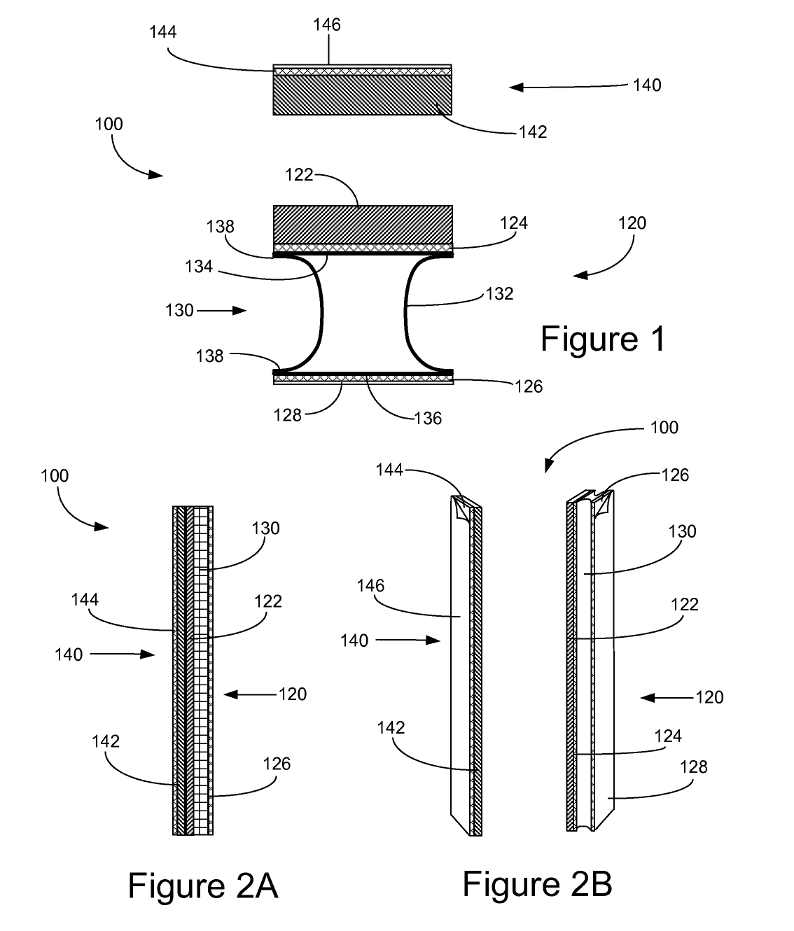

Magnetic weather stripping and systems as described in this application may have any configuration consistent with the details and general principles of use as described below. An exemplary configuration of magnetic weather stripping 100 is illustrated in FIGS. 1-4B. Magnetic weather stripping 100 may include a cooperating pair of components, compressible strip 120 and magnet strip 140. Compressible strip 120 and magnet strip 140 may be used cooperatively to provide a weather seal to a variety of doors, windows, or other openings 10 by eliminating gaps between the door or window and the frame. The magnetic components of each of compressible strip 120 and magnet strip 140 may engage together to form a seal in the interface between doors or windows, and their frames, while also providing the advantages of an insulating weather strip.

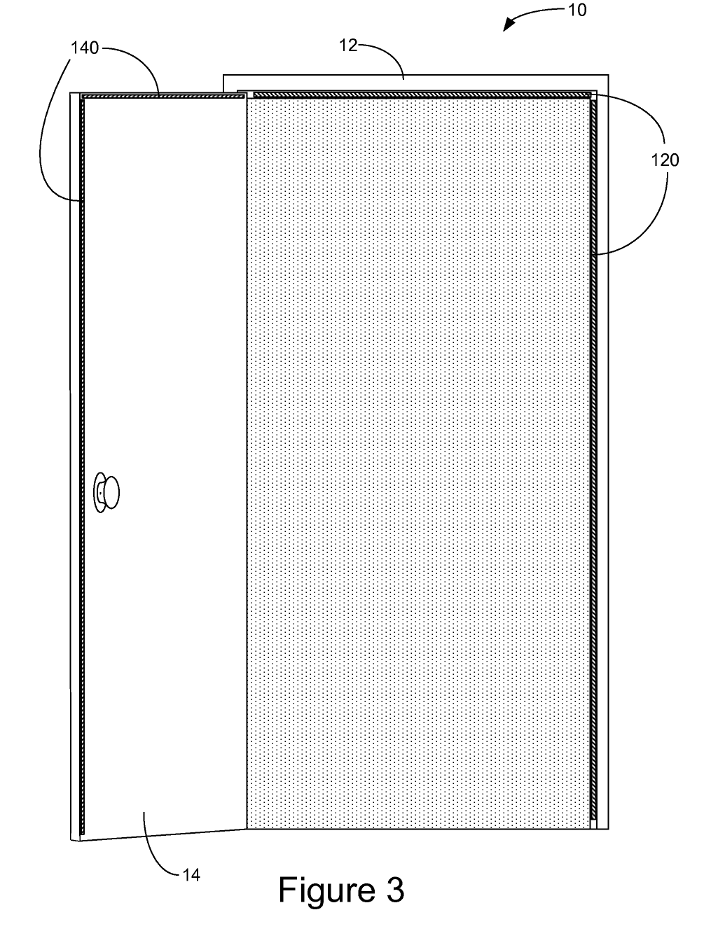

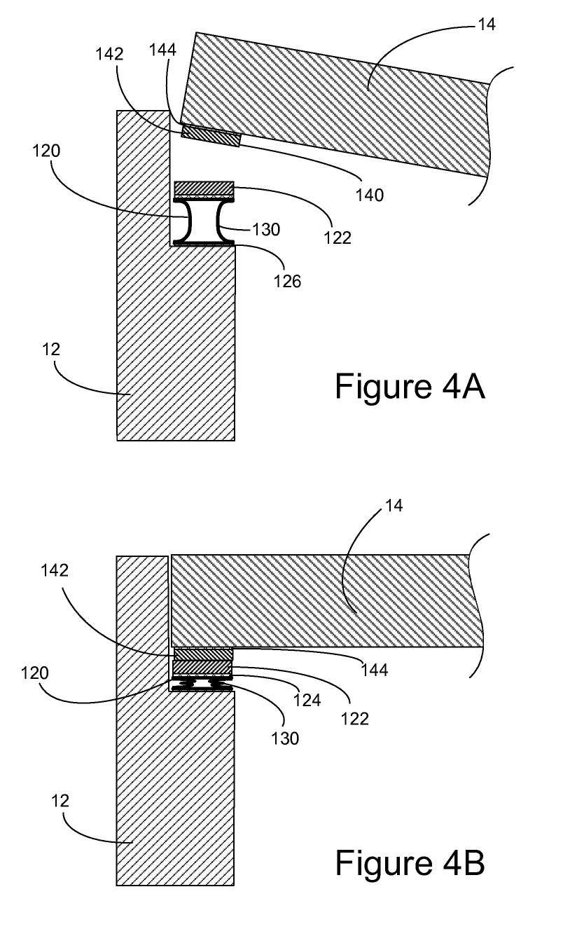

Compressible strip 120 may include strip magnet 122 attached to insulative core 130. As shown in the Figures, strip magnet 122 may be attached to insulative core 130 with adhesive 124. Insulative core 130 may also have a second adhesive 126 for attaching compressible strip to a door or window frame surface (12 in FIGS. 3-4B). Magnet strip 140 may be formed with strip magnet 142 and adhesive 144 for attaching magnet strip 140 to a window or door (14 in 3-4B).

Adhesive 124 may be double sided tape, contact adhesive, spray adhesive, epoxy, heat-activated adhesive, or any other adhesive suitable to permanently couple strip magnet 122 with insulative core 130. Similarly, adhesives 126, 144 may be double sided tape, contact adhesive, spray adhesive, epoxy, heat-activated adhesive, or any other adhesive suitable to permanently couple strip magnet 142 or insulative core 130 to the various surfaces used in windows and doors.

Strip magnets 122 and 142 may be formed from flexible strip magnets. Flexible strip magnets are generally available in rolls and are formed from a dry mixture of ferrite powder and rubber polymer resin formed by extrusion. The ferrite/polymer strip material is then magnetized, laminated with vinyl or adhesive, cut to size, and rolled onto a core. The strength of the magnetic strip may be in relation to the thickness of the flexible magnetic strips. In some embodiments, the thickness of strip magnet 122 and/or 142 may be between about 0.02 and 0.25 inches, depending on the amount of magnetic attraction desired. Commercially available flexible magnet strips having a thickness of 0.06 inches may be suitable.

In some embodiments, insulative core 130 may be formed of rubber, foam, vinyl, or other compressible material or configuration usable as weather stripping. As shown in FIG. 1, insulative core 130 may be formed of reinforced vinyl fabric formed generally into an I-shaped configuration. Insulative core may include ends 134, 136 attached at connection points 138 to sides 132. In some embodiments, ends 134, 136 may be heat sealed to sides 132 at connection points 138, with the vinyl fabric being melted, as shown in FIG. 1 to form a collapsible box or I-shape to provide compressibility and insulative properties. In other embodiments, ends and sides may be sewn or glued together to form the structure.

Thus, to form compressible strip 120, long strips of vinyl fabric may be provided and then attached together at connection points 138 to form the structure of insulative core 130, as described above. Strip magnet 122 may then be attached to insulative core 130 with adhesive 124. In some embodiments, strip magnet 122 may be provided in a roll with adhesive 124 already applied and having a release layer (not shown) protecting adhesive 124. The release layer may be removed and strip magnet 122 attached to end 134 of insulative core 130 with adhesive 124. Adhesive 126 and release layer 128 may be applied to end 136 of insulative core.

In some embodiments, the finished compressible strip 120 may be rolled up into a roll having enough length to accommodate one of various door sizes, or may be formed in rolls of 10′, 12′, 15′, 25′, 50′, or any desired length. Compressible strip 120 may then be cut to the desired length for the window or door to be weather sealed. Or, compressible strip 120 may be cut into particular sizes to be used with a door or window of a particular size. For example, for a standard 36″ exterior house door, three pieces of compressible strip 120 may be provided. Two of the pieces may be 78″ and one at 36″. Similarly, in some cases where weather stripping for the hinge side of the door is not necessary, two pieces, one at 78″ and the other at 36″ may be provided.

In one embodiment, the materials in particular dimensions used to form compressible strip 120 may be provided as follows. Four pieces of heat sealable material are provided to form insulative core 130; two pieces flat and 0.50 inches wide for ends 134, 136 and 10 feet long, and two pieces 0.875 inches wide for sides 132 and 10 feet long. The four pieces may then be attached together in a box or I-shape as shown in FIG. 1. Once insulative core 130 is formed, two pieces of double sided adhesive 124, 126 may be applied to the ends 134, 136 (respectively) of insulative core 130. Strip magnet 122 having the dimensions of 0.50 inches wide×0.060 inches high×10 foot long may then be applied to adhesive 124 on end 134. Adhesive 126 may then be used to attach insulative core 130 to frame 12 along an edge of the frame which will engage with a portion of door 14.

Next, double sided adhesive 144 may be attached to strip magnet 142 having the dimensions of 0.50 inches wide×0.060 inches high×10 foot long to form magnet strip 140. Magnet strip 140 may be applied to the operational door 14 along an edge corresponding to the edge of frame 12 where compressible strip 120 was applied. Thus, when door 14 is closed and comes near to frame 12, strip magnets 122 and 142 may be attracted to each other and attach to each other to form a seal in the gap between door 14 and frame 12.

When door 14 is opened, the strength of the magnets is insufficient to prevent a person from breaking the magnetic attraction and opening the door by separating strip magnets 122 and 142 from each other. As such, the strength of the various adhesives should be much stronger than the magnetic attraction between the strip magnets to ensure that weather stripping 100 is not destroyed or uninstalled during normal use.

On advantage to the systems described herein is that because magnets 122, 142 attract to each other, insulative core 130 may not require elastic properties such as are necessary in traditional weather stripping products. For example, when the magnets 122, 142 are in close proximity, they may attach to each other and insulative core 130 may vary in thickness depending on the thickness of the gap between door 14 and frame 12. Thus, insulative core 130 may use the magnetic attraction to magnets 122, 142 to perfectly contour to the interface between door 14 and frame 12 as best shown in FIG. 4B instead of elasticity as is done with traditional weather stripping. Of course, in some embodiments, compressive strip 120 may be attached to door 14 and magnetic strip 140 may be attached to frame 12.

In some embodiments, compressible strip 120 may include release layer 128 to protect adhesive 126 until compressible strip 120 is ready to be installed. Similarly, release layer 146 may be provided to protect adhesive layer 144 until installation. During installation, release layers 128, 146 may be removed and discarded. In other embodiments, strip magnet 122 may be embedded within insulative core 130, obviating the need for adhesive 124 on an exterior face of insulative core 130.

In some embodiments, compressible strip 120 may be used alone without magnet strip 140. For example, if a window or door is made of steel or other ferromagnetic material, strip magnet 122 of compressible strip 120 may attach to the door or window without the need for magnet strip 140. Similarly, some doors or windows may be made with an embedded metal strip or magnet to act as a connection for strip magnet 122 of compressible strip 120. Similarly, in some embodiments where there is a metal door or window frame and a wooden door or window, compressible strip 120 may be applied to the door or window with no magnet strip being necessary.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. Weather stripping, comprising:
a compressible insulative core;
a strip magnet permanently affixed to a first surface of the insulative core; and
an adhesive layer applied to a second surface of the insulative core opposite the first surface of the insulative core.

2. The weather stripping of claim 1, wherein the compressible insulative core is formed using at least three strips of vinyl fabric.

3. The weather stripping of claim 2, wherein the at least three strips of vinyl fabric are connected to each other to form a general box or I-shape.

4. The weather stripping of claim 3 wherein the at least three strips of vinyl fabric is four strips.

5. The weather stripping of claim 1, wherein the weather stripping is configured to be attached to the frame of a door or window using the adhesive layer.

6. The weather stripping of claim 1, further comprising magnet strip.

7. The weather stripping of claim 6, wherein the magnet strip includes an adhesive layer configured to attach to magnet strip to a door or window.

8. The weather stripping of claim 1, wherein the weather stripping is packaged and shipped in a roll.

9. The weather stripping of claim 1, wherein the adhesive layer is protected with a release layer prior to installation of the weather stripping.

10. (canceled)

11. (canceled)

12. (canceled)

13. (canceled)

14. (canceled)

15. (canceled)

16. (canceled)

17. (canceled)

18. (canceled)

19. (canceled)
